(19) United States
(12) Patent Application Publication
(10) Pub. No.: US 2013/0117176 A1
(43) Pub. Date: May 9, 2013

(54) Key Box Apparatus

(71) Applicant: Tydon Oler, South Jordan, UT (US)

(72) Inventor: Tydon Oler, South Jordan, UT (US)

(21) Appl. No.: 13/671,704

(22) Filed: Nov. 8, 2012

Related U.S. Application Data
(60) Provisional application No. 61/557,078, filed on Nov. 8, 2011.

(51) Int. Cl. B65D 50/00; G06Q 20/04

(52) U.S. Cl. CPC B65D 50/00; G06Q 20/04
USPC 705/39; 220/212

(57) ABSTRACT

The present invention generally relates to key boxes, like those utilized in the real estate industry. Specifically, this invention relates to a key box apparatus configured to identify and validate a user's access to the contents of the key box via a verification module. Additionally, exemplary embodiments of the key box apparatus may be utilized to charge a fee for accessing the contents of the key box.

### CROSS-REFERENCE TO RELATED APPLICATIONS

This application claims the benefit of U.S. Patent Application No. 61,557,078 filed Nov. 8, 2011, the entire disclosure of which is incorporated herein by reference.

### FIELD OF THE INVENTION

The present invention generally relates to key boxes, like those utilized in the real estate industry. Specifically, this invention relates to a key box apparatus configured to identify and validate a user's access to the contents of the key box via a verification module. Additionally, exemplary embodiments of the key box apparatus may be utilized to charge a fee for accessing the contents of the key box.

### BACKGROUND

Key boxes are used in a variety of industries where access by numerous individuals is desired without requiring a key to be handed from individual to individual in person. An example of such an industry is residential and commercial real estate sales/rentals. It is not uncommon for a real estate company to hang a key box on the door of a piece of real estate that is available for sale or rent, allowing other real estate agents or individuals to access and show the piece of real estate without the presence of an employee or other agent from the listing company.

Most commonly, these key boxes are released through the use of an access code or other coded means. Some of the drawback with this is that these key boxes can be accessed by anyone who knows the code or has access to the coded means and such access is not recorded by the key box. In this manner, there is no way to know who accessed the key box or how many times it has been accessed.

Further, continuing with the real estate example, since real estate may be shown over and over by those who are not serious about purchasing or renting a particular property, it would be advantageous for a key box to provide a deterrent to these types of individuals. Key boxes currently in use lack any ability to engage in such a deterrent process.

Additionally, since those who access the contents of a key box can do damage or cause other harm or expense to the property secured by the key, it would be advantageous to keep and retain records of who accessed the key box. This is currently impossible with key boxes in present use.

Therefore, there is need in the art for a key box apparatus configured to identify and validate a user's access to the contents of the key box via a verification module. These and other features and advantages of the present invention will be explained and will become obvious to one skilled in the art through the summary of the invention that follows.

### SUMMARY OF THE INVENTION

Accordingly, it is an aspect of the present invention to provide a key box apparatus configured to identify and validate a user's access to the contents of the key box via a verification module.

According to an embodiment of the present invention, a key box apparatus includes: a housing; a secured container removably receivable within said housing and configured to retain one or more keys; a locking mechanism operably attached to said housing and configured to lock said secured container within said housing; and a verification module integrally formed with said housing and comprising a reader element and a verification element, wherein said reader element is configured to read identity information from one or more identification sources, and wherein said verification element is configured to confirm said identity information.

According to an embodiment of the present invention, the key box apparatus includes a communications element integrally formed with said housing.

According to an embodiment of the present invention, the communications element is configured to transmit said identity information to a remote computing device.

According to an embodiment of the present invention, the communications means is configured to transmit transaction data provided by said verification element.

According to an embodiment of the present invention, the communications element is configured to receive data from a remote computing device for use with the verification module.

According to an embodiment of the present invention, the key box apparatus includes an attachment means, wherein said attachment means is configured to allow the housing to be attached to a door knob.

According to an embodiment of the present invention, the key box apparatus includes an attachment means, wherein said attachment means is configured to allow the housing to be attached to a surface.

According to an embodiment of the present invention, the verification module further includes a display screen for providing information to a user of said key box apparatus.

According to an embodiment of the present invention, the verification module further includes a data entry element that allows for a user to input information for use by the verification module.

According to an embodiment of the present invention, the data entry element is a keypad.

According to an embodiment of the present invention, the data entry element is a touchscreen.

According to an embodiment of the present invention, a method for providing access to a key box apparatus and validating, the method comprising the steps of: receiving identification information from a user at a reader element of said key box apparatus; verifying said identification information at a verification element of said key box apparatus; unlocking a locking mechanism of said key box apparatus by way of communicating an unlock signal to said locking mechanism from said verification element.

According to an embodiment of the present invention, the method includes the step of storing verification information.

According to an embodiment of the present invention, the method includes the step of transmitting verification information to a remote computing device via a communications element.

According to an embodiment of the present invention, the method includes the step of processing a payment transaction based at least in part on said identification information.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a front view of a key box apparatus, in accordance with an embodiment of the present invention;

FIG. 2 is a side view of a key box apparatus, in accordance with an embodiment of the present invention;

FIG. 3 is a rear view of a key box apparatus, in accordance with an embodiment of the present invention;

FIG. 4 is a front view of a key box apparatus, in accordance with an embodiment of the present invention;

FIG. 5 is a side view of a key box apparatus, in accordance with an embodiment of the present invention;

FIG. 6 is a bottom view of a key box apparatus, in accordance with an embodiment of the present invention;

FIG. 7 is a top view of a key box apparatus, in accordance with an embodiment of the present invention;

FIG. 8A is a top view of a key box apparatus, in accordance with an embodiment of the present invention;

FIG. 8B is a bottom view of a key box apparatus, in accordance with an embodiment of the present invention;

FIG. 8C is a side view of a key box apparatus, in accordance with an embodiment of the present invention;

FIG. 8D is a side view of a key box apparatus, in accordance with an embodiment of the present invention;

FIG. 8E is a rear view of a key box apparatus, in accordance with an embodiment of the present invention;

FIG. 8F is a front view of a key box apparatus, in accordance with an embodiment of the present invention; and

FIG. 9 is a perspective view of a key box apparatus, in accordance with an embodiment of the present invention.

### DETAILED SPECIFICATION

The present invention generally relates to key boxes, like those utilized in the real estate industry. Specifically, this invention relates to a key box apparatus configured to identify and validate a user's access to the contents of the key box via a verification module. Additionally, exemplary embodiments of the key box apparatus may be utilized to charge a fee for accessing the contents of the key box.

According to an embodiment of the present invention, a key box apparatus is provided for use in situations where retention of a key or other article within a secured and controlled environment, with access being limited to a select number of individuals. In certain embodiments of the present invention, the actual number of individuals or the identity of the specific individuals permitted to access the key box apparatus may not be known. In these embodiments, certain characteristics, traits or other indicia may be utilized to permit these individuals to have access to the key box apparatus described herein.

Embodiments of the present invention are configured for use in the real estate industry, where providing access to a key is desirably limited to only qualified individuals (e.g., registered real estate agents, REALTORs). While certain preferred embodiments may be tailored for use in the real estate industry, one of ordinary skill in the art would appreciate that there are numerous industries and scenarios embodiments of the present invention could be utilized for, and embodiments of the present invention are contemplated for use in any applicable scenario and industry. Certain preferred embodiments are described below.

According to an embodiment of the present invention, the key box apparatus may be comprised of a secured container, a locking mechanism and a verification module. In a preferred embodiment, the secured container is comprised of a box like structure made from a material capable of withstanding considerable force while protecting and securing the contents contained within. For instance, the secured container may be a box comprised of a plurality of walls, forming a cavity for the retention of a key or set of keys, and constructed from a rigid, nonmalleable material. Nonmalleable materials may include, but are not limited to, steel, ceramics, hardened plastics, ruggedized rubbers, non-pliable metals, other reinforced materials or any combination thereof. One of ordinary skill in the art would appreciate that there are numerous materials the secured container may be constructed from, and embodiments of the present invention are contemplated for use with any appropriate material. The secured container may be further configured to protect the contents from inclement weather, such as rain and snow. This may be achieved by providing one or more weather tight seals around portions of the secured container that may open and close.

According to an embodiment of the present invention, the locking mechanism is constructed with or otherwise secured to the secured container in a manner that allows for the locking mechanism to be releasably utilized to secure the secured container in a closed or otherwise inaccessible manner. For instance, the locking mechanism may be a sliding panel, twist-lock seal, magnetic drop panel or a hinged mechanism. One of ordinary skill in the art would appreciate that there are numerous types of locking mechanisms that may be utilized with embodiments of the present invention, and embodiments of the present invention are contemplated for use with any type of locking mechanism.

According to an embodiment of the present invention, the verification module is formed on, upon or in the key box apparatus and is configured to verify a user's identity and, if appropriately verified, release the locking mechanism and allow the user access to the contents of the secured container. In a preferred embodiment, the verification module is comprised of a reader element and a verification element.

The reader element is configured to read one or more types of identification or payment sources. For instance, a reader element may read one or more of a credit card, debit card, RFID device, key fob, near field communication (NFC) signal or biometric information. In a preferred embodiment, the reader element may be comprised of a magnetic card reader (e.g., credit card reader, debit card reader, identification card reader). The reader element is configured to receive information from the method provided by the user and provide said information to the verification element. The information may include, but is not limited to, identification information, payment information, order information, registration information and verification information. One of ordinary skill in the art would appreciate that there are numerous types of information that may be read by the reader element, and embodiments of the present invention are contemplated for use with any form of information.

According to an embodiment of the present invention, the reader element may be further comprised of one or more input means. Input means include, but are not limited to, keypads, keyboards, touchscreens, camera, microphone, card reader, USB port, NFC means and Bluetooth means. One of ordinary skill in the art would appreciate that numerous types of input means may be utilized with embodiments of the present invention, and embodiments of the present invention are contemplated for use with any input means.

According to an embodiment of the present invention, the input means are configured to allow the reader element to gather additional information to be utilized with the verification process. For instance, a keypad may be utilized to receive a Pin Number, a camera may be utilized to take a photo of the individual requesting access or a keyboard could be utilized to enter the name, address, phone number and/or email address of the individual requesting access. One of ordinary skill in the art would appreciate that there are numerous types of additional information that could be gathered by the input means, and embodiments of the present invention are contemplated for use with any type of additional information.

In an alternate embodiment, the reader element may be comprised of a wired or wireless connection port which allows an individual to connect a remote reader element to the apparatus for provision of verification information. For instance, a reader component may allow a USB connection or a Bluetooth connection from a smartphone, whereby the smartphone would provide verification or payment information (e.g., via online payment services, via credit card or other billing attachments) to the reader element for processing by the verification element described below. In this embodiment, the reader element only needs to have the ability to allow the connection from remote devices, and not have its own integrated reading means or input means.

According to an embodiment of the present invention, the verification element is configured to utilize the information provided from the reader element, and potentially one or more other variables/characteristics, to verify one or more of an identify of the user, point of sale transaction, validity of an access request or any combination thereof. In a preferred embodiment, the verification element is comprised of a computing device operable to receive said information and process one or more requests related to said information. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). One of ordinary skill in the art would understand that any number of computing devices could be used, and embodiments of the present invention are contemplated for use with any computing device.

In a preferred embodiment, a verification element may be comprised of a self-contained micro-computing device designed to be installed directly within the apparatus described herein. Power for the verification element may be derived from a small battery, direct power connection, rechargeable source (e.g., small solar panel) or any combination thereof. The verification element device may also be configured to go into a standby mode to conserve power between interactions with users.

According to an embodiment of the present invention, the verification element may be comprised of verification processing software. The verification processing software is configured to process information received by the verification element from the reader element in order to confirm individual requests for access to the contents of the secured container. The verification processing software may be configured to utilize the information provided from the reader element in conjunction with other variables (e.g., time of day, number of requests by the particular individual, date, whether the secured container has already be accessed by another individual within a set period of time) in order to determine whether an individual should be provided access to the contents of the secured container.

According to an embodiment of the present invention, the verification software may be configured to allow any individual with a valid credit card/debit card or other payment source to have access to the contents of the secured container. In this manner, access to the contents are limited only by an individual's ability to pay the fee set by the owner to access the secured container. Optionally, embodiments in this form may be configured to place a hold on the individual's payment source account (e.g., credit card account, debit card account) to insure that if any damage occurs through the individual's use of the contents of the secured container, that those damages may be deducted from the held funds.

In a preferred embodiment, the verification element may be further comprised of a communication element that allows the verification element to transmit and receive information over one or more communication systems (e.g., Wi-Fi, Bluetooth, CDMA, GSM, Local Area Network (LAN), NFC). In this manner, the verification element can be configured to provide real-time verification and payment information by confirming certain information (e.g., credit card number, user identity) with a remote verification system.

In a preferred embodiment of the present invention, transmission and receipt of information from the communication element may be encrypted to protect the security of the communications. One of ordinary skill in the art would appreciate that there are numerous ways to encrypt the communications from the communications element, and embodiments of the present invention are contemplated for use with any form of encrypted communications.

Embodiments of the present invention allow for the apparatus to capture and store or send information regarding the identity of a user as well as other data points (e.g., time of date, date, amount of time secured container was left open).

Embodiments of the present invention may be configured to allow an individual who has previously accessed the secured container to access the secured container again without requiring additional payment or additional verification (e.g., simply enter a code given to the individual or re-swipe the identification previously used).

In relation to the real estate industry or similar industry, the apparatus may allow operators of the apparatus to generate income from its use. In the case of property management companies, charging a payment per showing or use could generate substantial income for the user.

Embodiments of the present invention may further be utilized to record metrics of how often individuals visit the apparatus, how much income per time interval is generated, how long each visit is and many other metrics associated with access to the apparatus. The apparatus may also record failed verification attempts and potentially alert the owner or other authority if numerous failed attempts occur within a select period of time or other data point.

Embodiments of the present invention may also deter non-serious buyers/renters from visiting the property secured by the apparatus. If an individual is not serious about entering into a transaction for the property, he/she will be less likely to pay the access fee. This in turn will reduce owner/manager time spent monitoring and showing properties.

Embodiments of the present invention may further be utilized to maintain payment information regarding individuals who visit the property in order to charge the individual in the event of an incident. Incidents may include, but are not limited to, failure to return the key to the key box apparatus or damage done by the individual to the property. One of ordinary skill in the art would appreciate that there are numerous types of incidents that may be handled by the apparatus and embodiments of the present invention are contemplated for use with any type of incident.

Embodiments of the present invention may further be utilized to allow an individual to submit an application or hold fee for the associated rental/sale property. By submitting this information, the key box apparatus may be configured to not allow any further access to the contents of the secured container of the key box apparatus. This allows a serious buyer/renter to place a hold on the apparatus in exchange for a fee processed by the verification element of the key box apparatus.

Embodiments of the present invention may further be utilized to allow the user to receive a rental application from the key box apparatus via a communication element. In this manner, the apparatus may be configured to transmit and potentially receive a rental application from an individual accessing the key box apparatus.

Embodiments of the present invention be further configured to identify unauthorized access attempts or attempts to access the secured container by force. In these cases, the owner or other authority may be notified of the attempts. Additionally, the apparatus may be configured to sound an alarm of other alert to notify the intruder or others nearby of the unauthorized access attempt. If the unauthorized access attempt occurred within a short period of time from a last access by an individual, that individual's information may also be provided to the authorities as a person of interest in connection with the unauthorized access attempt.

Embodiments of the present invention can be utilized in business parks, vehicles, parking lots or other place where access can be controlled by a key. One of ordinary skill in the art would appreciate that there are numerous settings in which embodiments of the apparatus could be utilized, and embodiments of the present invention are contemplated for use in any scenario.

According to an embodiment of the present invention, the apparatus may be further comprised of an attachment means configured to allow the apparatus to be attached to a door. For instance, a releasable locking hook could be used to allow for the apparatus to be hung around a door knob and locked into place so that individuals cannot remove or otherwise steal the apparatus from its secured position. In other embodiments, the attachment means could include, but are not limited to, screw mounts, adhesives, locking pins or any combination thereof. One of ordinary skill in the art would appreciate that there are numerous types of attachment means that could be utilized with embodiments of the present invention, and embodiments of the present invention are contemplated for use with any type of attachment means.

### EXEMPLARY EMBODIMENTS

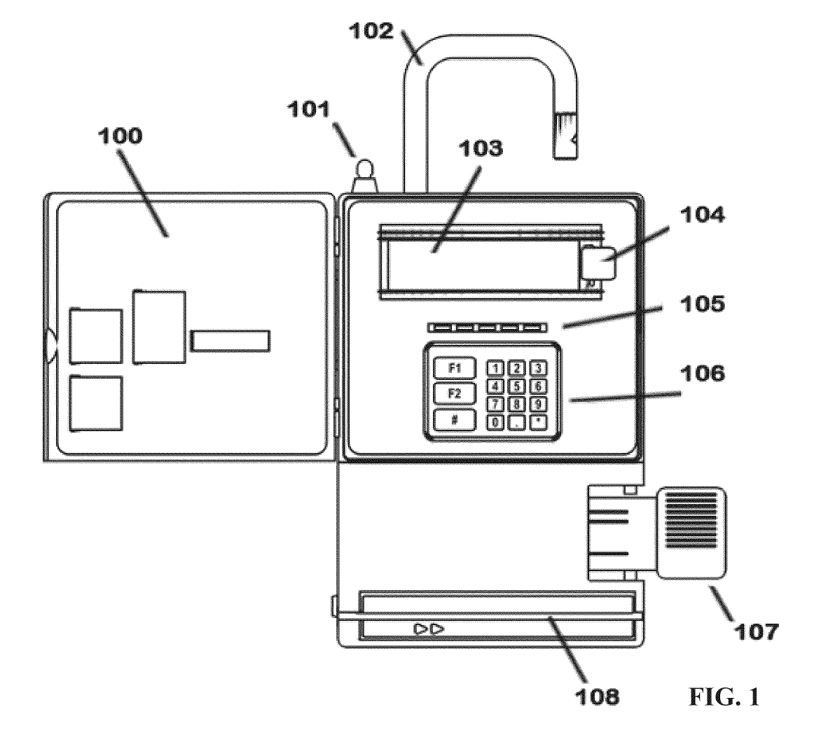

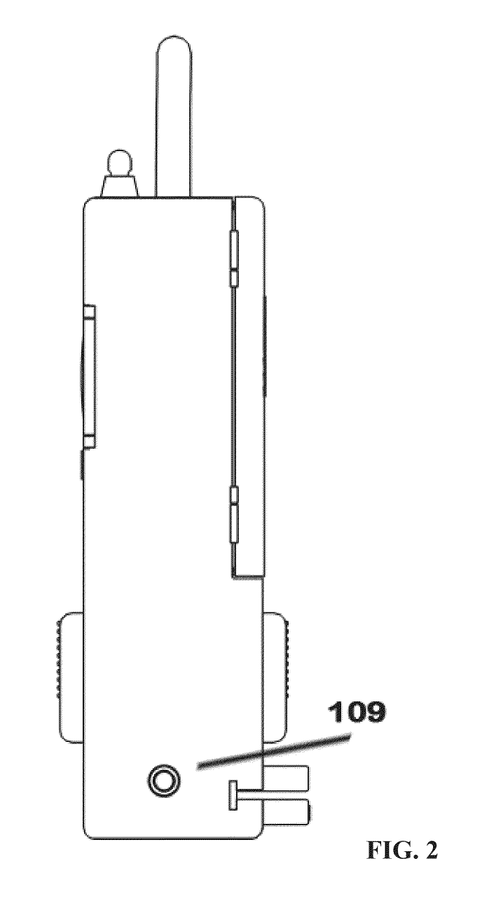

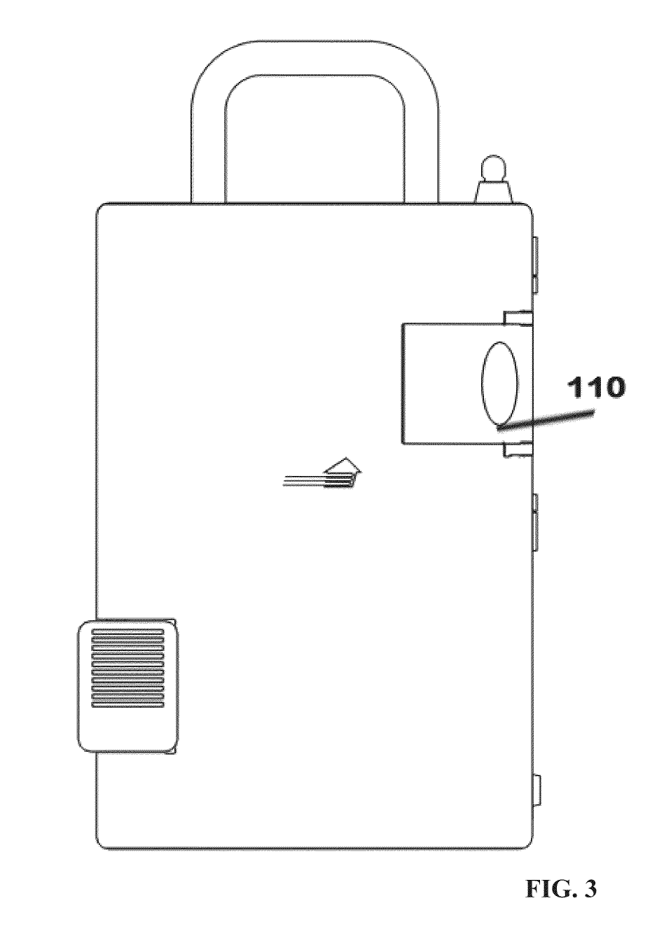

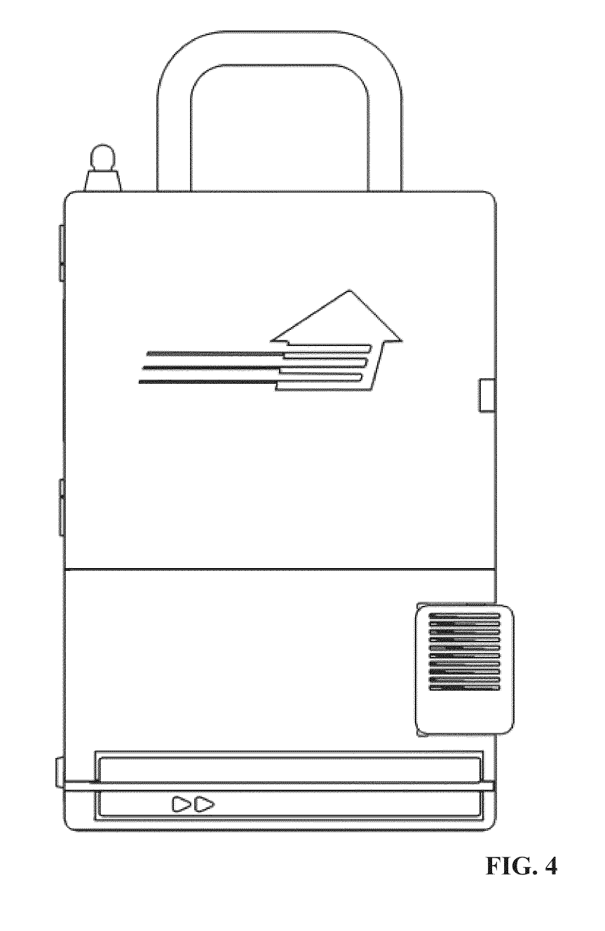

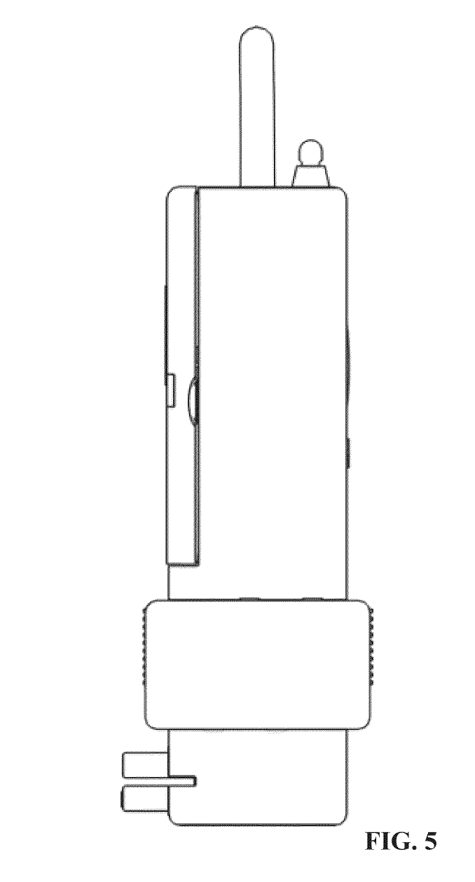

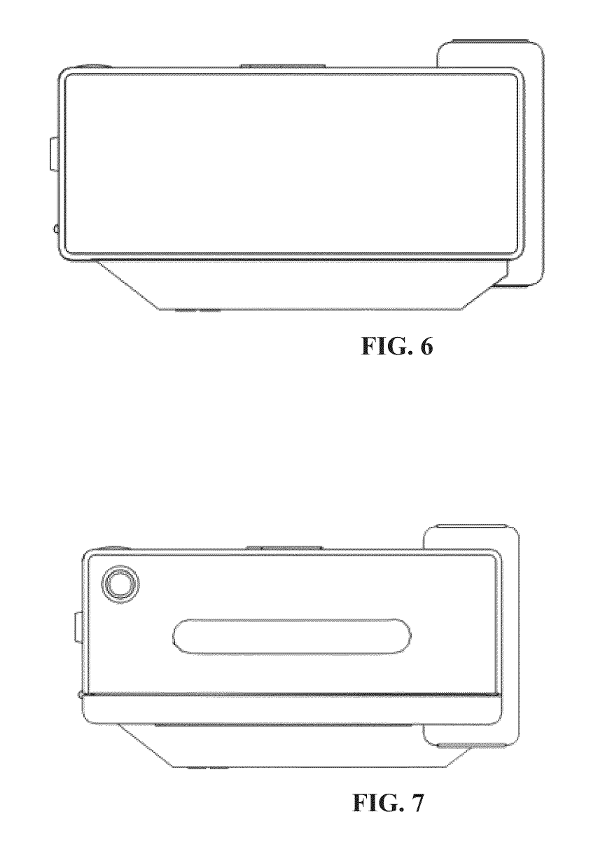

Turning now to FIGS. 1-7, an exemplary embodiment of a key box apparatus is shown. In this embodiment, the key box apparatus is comprised of a housing with an access panel 100, communications antenna 101, attachment means 102 for securing the device to or hanging the device from a door, display panel 103, camera 104, indicator lights 105, key pad 106, secured container 107 and reader element 108, power/data port 109 and a battery compartment 110.

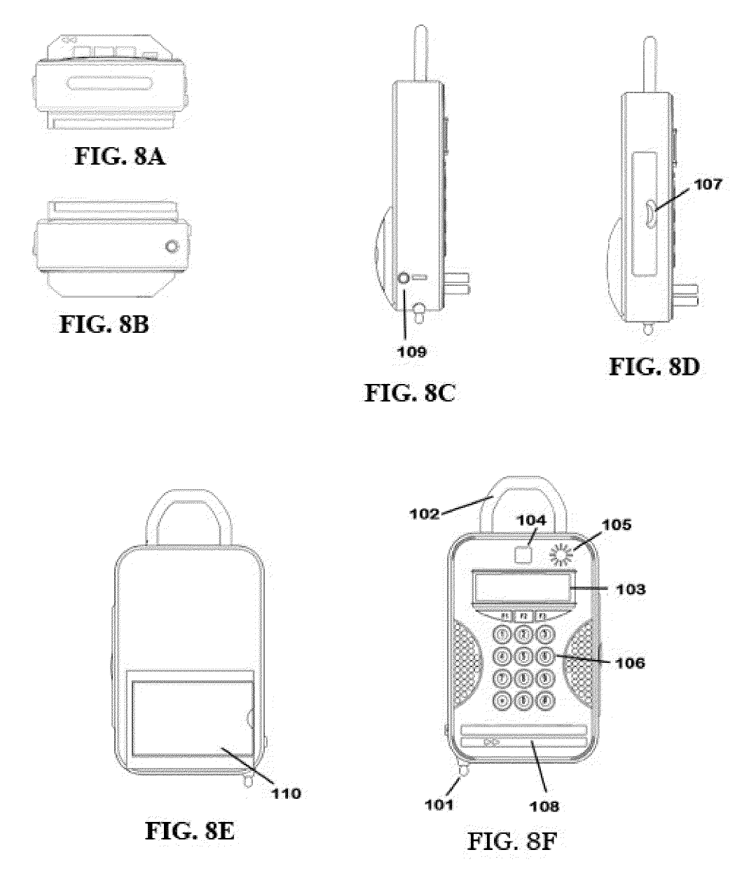

Turning now to FIGS. 8A-8F, an alternative exemplary embodiment of a key box apparatus is shown. In this embodiment, the key box apparatus is comprised of a housing with an access panel 100, communications antenna 101, attachment means 102 for securing the device to or hanging the device from a door, display panel 103, camera 104, indicator light 105, key pad 106, secured container 107 and reader element 108, power/data port 109 and a battery compartment 110.

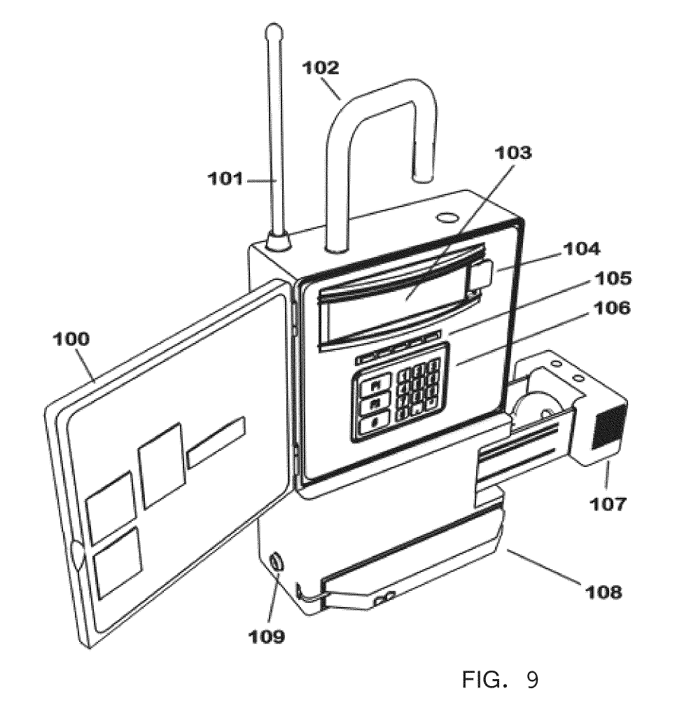

Turning now to FIG. 9, a second alternative exemplary embodiment of a key box apparatus is shown. In this embodiment, the key box apparatus is comprised of a housing with an access panel 100, communications antenna 101 (shown fully extended, but can be retractable), attachment means 102 for securing the device to or hanging the device from a door, display panel 103, camera 104, indicator light 105, key pad 106, secured container 107 and reader element 108, and power/data port 109.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A key box apparatus comprising:
a housing;
a secured container removably receivable within said housing and configured to retain one or more keys;
a locking mechanism operably attached to said housing and configured to lock said secured container within said housing; and
a verification module integrally formed with said housing and comprising a reader element and a verification element,
wherein said reader element is configured to receive payment information from one or more payment sources, and
wherein said verification element is configured to confirm said payment information.

2. The key box apparatus of claim 1, further comprising a communications element integrally formed with said housing.

3. The key box apparatus of claim 2, wherein said communications element is configured to transmit said payment information to a remote computing device.

4. The key box apparatus of claim 2, wherein said communications means is configured to transmit transaction data provided by said verification element.

5. The key box apparatus of claim 2, wherein said communications element is configured to receive data from a remote computing device for use with the verification module.

6. The key box apparatus of claim 1, further comprising an attachment means, wherein said attachment means is configured to allow the housing to be attached to a door knob.

7. The key box apparatus of claim 1, further comprising an attachment means, wherein said attachment means is configured to allow the housing to be attached to a surface.

8. The key box apparatus of claim 1, wherein said verification module further comprises a display screen for providing information to a user of said key box apparatus.

9. The key box apparatus of claim 1, wherein said verification module further comprises a data entry element that allows for a user to input information for use by the verification module.

10. The key box apparatus of claim 9, wherein said data entry element is a keypad.

11. The key box apparatus of claim 9, wherein said data entry element is a touchscreen.

12. The key box apparatus of claim 9, wherein said data entry element is a camera.

13. A method for providing access to a key box apparatus and validating, the method comprising the steps of:
receiving payment information from a user at a reader element of said key box apparatus;
verifying said payment information at a verification element of said key box apparatus;
unlocking a locking mechanism of said key box apparatus by way of communicating an unlock signal to said locking mechanism from said verification element.

14. The method of claim 13, further comprising the step of storing payment information.

15. The method of claim 13, further comprising the step of transmitting payment information to a remote computing device via a communications element.
